(19) United States
(12) Patent Application Publication
(10) Pub. No.: US 2026/0246036 A1
(43) Pub. Date: Aug. 20, 2026

(54) SECONDARY BATTERY AND METHOD FOR MANUFACTURING SAME

(71) Applicant: SAMSUNG SDI CO., LTD., Yongin-si (KR)

(72) Inventors: Hiroshi SEINO, Yongin-si (KR); Jeongchull AHN, Yongin-si (KR); Sanghyun KIM, Yongin-si (KR); Daesik KIM, Yongin-si (KR)

(21) Appl. No.: 19/374,097

(22) Filed: Oct. 30, 2025

(30) Foreign Application Priority Data
Feb. 20, 2025 (KR) 10-2025-0022039

(51) Int. Cl. H01M 50/141; H01M 10/04; H01M 50/103; H01M 50/121; H01M 50/15

(52) U.S. Cl. CPC H01M 50/141; H01M 10/049; H01M 50/103; H01M 50/121; H01M 50/15

(57) ABSTRACT

A secondary battery including an electrode assembly including a first electrode, a second electrode, and a separator; and a case accommodating the electrode assembly and an electrolyte, wherein the case includes a plastic material including a base resin and a filler.

### CROSS-REFERENCE TO RELATED APPLICATION

The present application claims priority to and the benefit of Korean Application No. 10-2025-0022039, filed on Feb. 20, 2025, in the Korean Intellectual Property Office, the entire disclosure of which is incorporated by reference herein.

### BACKGROUND

### 1. Field

Embodiments relate to a secondary battery and a method of manufacturing the secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes, e.g., an electrode assembly composed of a positive electrode and a negative electrode, a case accommodating the same, and electrode terminals connected to the electrode assembly.

The above information disclosed in this Background section is provided to enhance understanding of the background of the present disclosure and may contain information that does not constitute related art.

### SUMMARY

Embodiments are directed to a secondary battery including an electrode assembly including a first electrode, a second electrode, and a separator, and a case accommodating the electrode assembly and an electrolyte, wherein the case includes a plastic material including a base resin and a filler.

The plastic material may have a residual thickness of greater than or equal to 60% of an original thickness as measured by a thermomechanical analyzer under a compressive load of 0.2 N, at a measurement temperature of 300° C. to 400° C., and at a heating rate of 10° C./min.

The plastic material may have a density of less than or equal to 4.0 g/cm³.

The plastic material may have a water-vapor transmission rate of less than or equal to 15 g/(m²·day) under conditions of 40° C., a relative humidity of 90%, and standard atmospheric pressure.

The plastic material may have a tensile strength of greater than or equal to 50 MPa.

The plastic material may have a thickness of 100 μm to 300 μm.

The base resin may include a thermosetting resin including an epoxy resin, an amino resin, a phenolic resin, a polyester resin, a polyurethane resin, a melamine resin, or a polyimide resin.

The base resin may include a thermoplastic resin including a polypropylene resin, a polyethylene resin, or a polyacrylic acid resin.

The plastic material may include 5 wt % to 80 wt % of the filler, based on a total weight of the plastic material.

The filler may include an inorganic filler including a carbonate filler, a sulfate filler, a metal-oxide filler, a composite-oxide filler, a metal-hydroxide filler, a metal-nitride filler, or a carbon-based filler.

The plastic material may include an additive including a catalyst, a plasticizer, a lubricant, a cross-linking agent, a desiccant, a release agent, or a flame retardant.

The plastic material may be cross-linked by electron-beam irradiation, heat, or a chemical cross-linking agent.

The case may include a case body having an open side and including a first electrode terminal electrically connected to the first electrode and a second electrode terminal electrically connected to the second electrode, and a case cover coupled to the open side of the case body.

The case body and the case cover may be a single continuous component and the case cover may extend from one end of the case body and may be bent and coupled to the open side of the case body.

Embodiments are directed to a method of manufacturing a secondary battery, the method including manufacturing an electrode assembly including a first electrode, a second electrode, and a separator, manufacturing a case body having an open side and a case cover, coupling a first electrode terminal and a second electrode terminal to the case body, electrically connecting the first electrode to the first electrode terminal and electrically connecting the second electrode to the second electrode terminal, accommodating the electrode assembly in the case body, and coupling the case cover to the open side of the case body, wherein the case body and the case cover are formed of a plastic material including a base resin and a filler.

The plastic material may have a residual thickness of greater than or equal to 60% of an original thickness as measured by a thermomechanical analyzer under a compressive load of 0.2 N, at a measurement temperature of 300° C. to 400° C., and at a heating rate of 10° C./min.

The plastic material may have a density of less than or equal to 4.0 g/cm³.

The plastic material may have a water-vapor transmission rate of less than or equal to 15 g/(m²·day) under conditions of 40° C., a relative humidity of 90%, and standard atmospheric pressure.

The plastic material may have a tensile strength of greater than or equal to 50 MPa.

The plastic material may include 5 wt % to 80 wt % of the filler, based on a total weight of the plastic material.

### BRIEF DESCRIPTION OF THE DRAWINGS

Features will become apparent to those of skill in the art by describing in detail exemplary embodiments with reference to the attached drawings in which:

FIG. 1 is a plan view illustrating an example of a secondary battery according to some embodiments of the present disclosure.

FIG. 2 is an exploded perspective view illustrating an example of a secondary battery according to some embodiments of the present disclosure.

FIG. 3 is a cross-sectional view illustrating an example of a cut taken along the A-A line of FIG. 1.

FIG. 4 is a perspective view illustrating a state of manufacturing a case of a secondary battery according to some embodiments of the present disclosure.

FIG. 5 is a perspective view illustrating an example in which electrodes of an electrode assembly are electrically connected to electrode terminals of a case body in a secondary battery according to some embodiments of the present disclosure.

FIG. 6 is a perspective view illustrating an example in which, after the electrode assembly is accommodated in the case body of a secondary battery according to some embodiments of the present disclosure, a case cover is coupled to the case body.

FIG. 7 is a perspective view illustrating an example of a case of a secondary battery according to other embodiments of the present disclosure.

FIG. 8 is a perspective view illustrating a state of manufacturing a case of a secondary battery according to other embodiments of the present disclosure.

FIG. 9 is a perspective view illustrating an example in which electrodes of an electrode assembly are electrically connected to electrode terminals of a case body in a secondary battery according to other embodiments of the present disclosure.

FIG. 10 is a perspective view illustrating an example in which, after the electrode assembly is accommodated in the case body of a secondary battery according to other embodiments of the present disclosure, a case cover is coupled to the case body.

FIG. 11 is a flowchart illustrating an example of a method of manufacturing a secondary battery according to some embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (or under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified. As used herein, the term “or” is not an exclusive term, e.g., “A or B” would include A, B, or A and B.

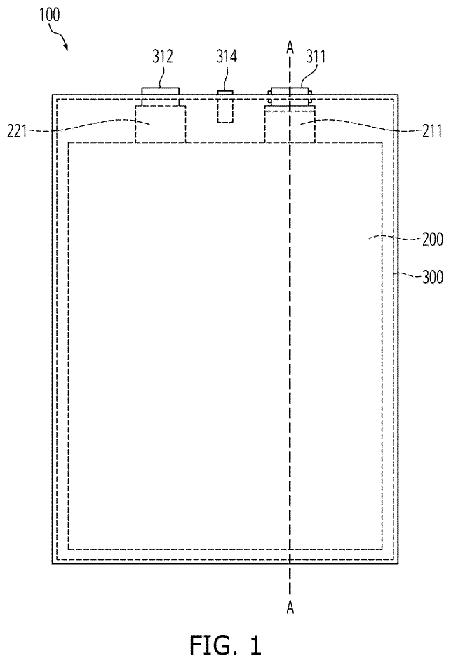

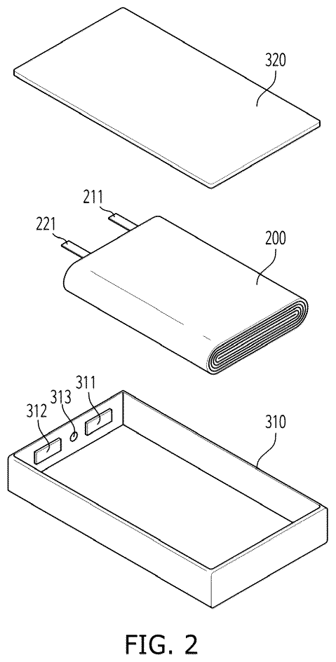

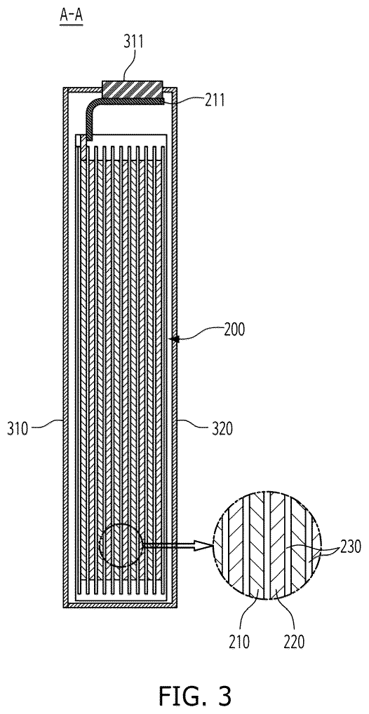

FIG. 1 is a plan view illustrating an example of a secondary battery according to some embodiments of the present disclosure; FIG. 2 is an exploded perspective view illustrating an example of a secondary battery according to some embodiments of the present disclosure; and FIG. 3 is a cross-sectional view illustrating an example of a cut taken along the A-A line of FIG. 1.

Referring to FIGS. 1 through 3, a secondary battery 100 according to some embodiments of the present disclosure may include, e.g., an electrode assembly 200 that includes a first electrode 210, a second electrode 220, and a separator 230, and a case 300 that accommodates the electrode assembly 200 and an electrolyte.

In some embodiments, the case 300 may include, e.g., a case body 310 that accommodates the electrode assembly 200 through an open side and a case cover 320 that may be coupled to the open side of the case body 310. The case 300 may include a plastic material including, e.g., a base resin and a filler. Accordingly, the case body 310 and the case cover 320 may include an insulating plastic material. For example, the plastic material including a base resin and a filler may be, e.g., an insulating plastic material.

The case body 310 may accommodate the electrode assembly 200 through the open side and may include a first electrode terminal 311 electrically connected to the first electrode 210 of the electrode assembly 200 and a second electrode terminal 312 electrically connected to the second electrode 220 of the electrode assembly 200.

When the first electrode 210 of the electrode assembly 200 functions as a positive electrode and the second electrode 220 functions as a negative electrode, the first electrode terminal 311 may function as a positive terminal and the second electrode terminal 312 may function as a negative terminal. Because the case body 310 may include an insulating plastic material, no separate configuration may be required to electrically insulate the first electrode terminal 311 and the second electrode terminal 312 from the case body 310.

The case cover 320 may be manufactured separately from the case body 310 and, after the electrode assembly 200 is accommodated in the case body 310, may be coupled to the open side of the case body 310.

The case body 310 may include, e.g., an electrolyte inlet 313 through which an electrolyte can be injected. After the electrode assembly 200 is accommodated in the case body 310 and the open side of the case body 310 is sealed with the case cover 320, the electrolyte may be injected into an interior of the case body 310 through the electrolyte inlet 313. In order to prevent the injected electrolyte from leaking, a sealing member 314 may be coupled to the electrolyte inlet 313 to seal the electrolyte inlet 313. The sealing member 314 may be a sealing pin.

An electrode assembly 200 may be formed, e.g., by winding or stacking a stack of a first electrode 210, a separator 230, and a second electrode 220, which may be formed as thin plates or films. When the electrode assembly 200 is a wound stack, a winding axis may be parallel to the longitudinal direction of the case. In other embodiments, the electrode assembly 200 may be, e.g., a stack type rather than a winding type. The electrode assembly 200 may be, e.g., a Z-stack electrode assembly 200 in which a positive electrode plate and a negative electrode plate are inserted into both sides of a separator 230, which is then bent into a Z-stack. One or more electrode assemblies may be stacked such that long sides of the electrode assemblies are adjacent to each other and accommodated in the case body 310. The first electrode 210 of the electrode assembly 200 may act as a positive electrode, and the second electrode 220 may act as a negative electrode. Of course, the reverse is also possible. For example, the first electrode 210 of the electrode assembly 200 may act as a negative electrode, and the second electrode 220 may act as a positive electrode.

The first electrode 210 be formed by applying, e.g., a first electrode active material, e.g., a transition metal oxide, on a first electrode current collector formed of, e.g., a metal foil, e.g., aluminum or an aluminum alloy. The first electrode 210 may include, e.g., a first lead tab 211 that is a region to which the first electrode active material is not on. The first lead tab 211 may act as a current flow path between the first electrode 210 and the first current collector. In some embodiments, the first lead tab 211 may be formed by being cut in advance to protrude to the other side (e.g., the opposite side) of the electrode assembly when the first electrode 210 is manufactured, or the first electrode 210 may protrude to the other side of the electrode assembly more than (e.g., farther than or beyond) the separator without being separately cut.

The second electrode 220 may be formed by applying a, e.g., a second electrode active material, e.g., graphite or carbon, on a second electrode current collector formed of, e.g., a metal foil, e.g., copper, a copper alloy, nickel, or a nickel alloy. The second electrode 220 may include, e.g., a second lead tab 221 that is a region to which the second electrode active material is not on. The second lead tab 221 may act as a current flow path between the second electrode 220 and the second current collector. In some embodiments, when the second electrode 220 is manufactured, the second lead tab 221 may be formed by being cut in advance to protrude to one side of the electrode assembly 200, or the second lead tab 221 may protrude to one side of the electrode assembly 200 more than (e.g., farther than or beyond) the separator 230 without being separately cut.

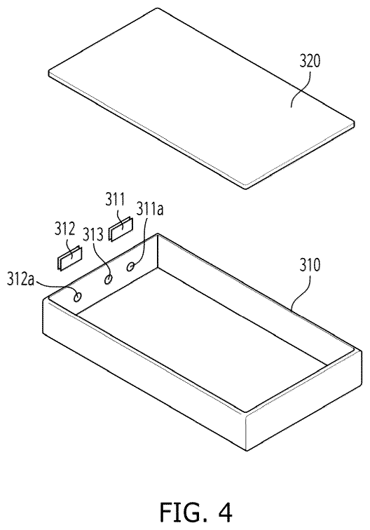

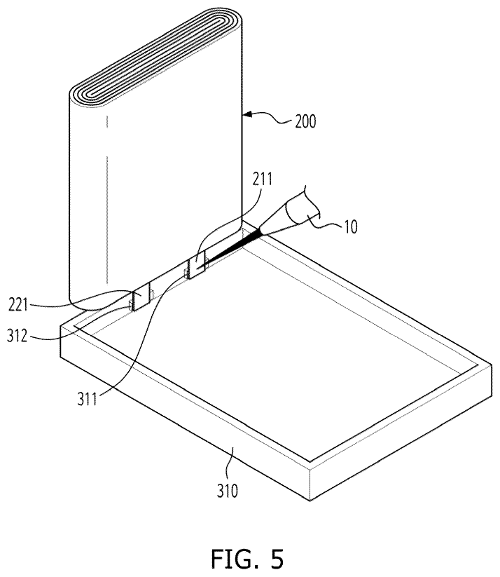

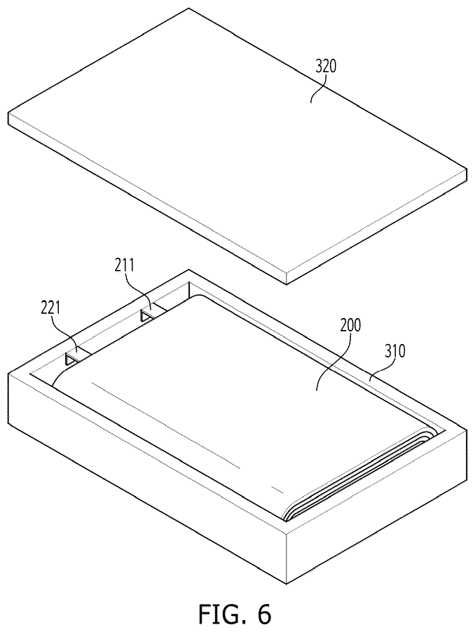

FIG. 4 is a perspective view illustrating a state of manufacturing a case of a secondary battery according to some embodiments of the present disclosure; FIG. 5 is a perspective view illustrating an example in which electrodes of an electrode assembly are electrically connected to electrode terminals of a case body in a secondary battery according to some embodiments of the present disclosure; and FIG. 6 is a perspective view illustrating an example in which, after the electrode assembly is accommodated in the case body of a secondary battery according to some embodiments of the present disclosure, a case cover is coupled to the case body.

Referring to FIGS. 4 through 6, the case 300 may include, e.g., the case body 310 and the case cover 320, and each of the case body 310 and the case cover 320 may include a plastic material including a base resin and a filler.

The case body 310 may have a rectangular-parallelepiped shape and have one open side. The first electrode terminal 311 and the second electrode terminal 312 may be coupled to a surface that is orthogonal to the open side of the case body 310.

In some embodiments, the case body 310 may include, e.g., a first coupling hole 311a and a second coupling hole 312a to which the first electrode terminal 311 and the second electrode terminal 312 are coupled, respectively. That is, the first coupling hole 311a and the second coupling hole 312a may be in the case body 310 including the plastic material, and the first electrode terminal 311 and the second electrode terminal 312 may be coupled to the first coupling hole 311a and the second coupling hole 312a, respectively. The first electrode terminal 311 and the second electrode terminal 312 may be insert-molded in a mold, and resin may be injected into the mold to integrally form the case body 310 together with the first electrode terminal 311 and the second electrode terminal 312. For example, the case body 310, the first electrode terminal 311, and the second electrode terminal 312 may be a single continuous component.

An electrolyte inlet 313 may be between the first coupling hole 311a and the second coupling hole 312a in the case body 310.

After the first electrode terminal 311 and the second electrode terminal 312 are coupled to the case body 310, the first lead tab 211 of the electrode assembly 200 may be coupled to the first electrode terminal 311, and the second lead tab 221 of the electrode assembly 200 may be coupled to the second electrode terminal 312, thereby being electrically connected. In some embodiments, the first lead tab 211 and the second lead tab 221 may be laser-welded to the first electrode terminal 311 and the second electrode terminal 312, respectively, by a laser device 10.

After the first lead tab 211 and the second lead tab 221 are coupled to the first electrode terminal 311 and the second electrode terminal 312, respectively, the first lead tab 211 and the second lead tab 221 may be bent, and the electrode assembly 200 may be accommodated in the case body 310. Then, the case cover 320 may be disposed on the open side of the case body 310, and then coupled to the case body 310 to seal it. The case body 310 and case cover 320 may be coupled by, e.g., laser welding or thermal fusion.

In some embodiments, the base resin may include, e.g., a thermosetting resin including, e.g., an epoxy resin, an amino resin, a phenolic resin, a polyester resin, a polyurethane resin, a melamine resin, and a polyimide (PI) resin. The base resin may include, e.g., a thermoplastic resin including, e.g., a polypropylene (PP) resin, a polyethylene (PE) resin, or a polyacrylic acid (PAA) resin.

The filler may include, e.g., an inorganic filler, e.g., a carbonate filler, a sulfate filler, a metal-oxide filler, a composite-oxide filler, a metal-hydroxide filler, a metal-nitride filler, or a carbon-based filler.

In some embodiments, the inorganic filler may include, e.g., calcium carbonate, barium sulfate, talc, mica, potassium titanate, silica, natural minerals, titanium oxide, zinc oxide, alumina, boehmite, aluminum hydroxide, boron nitride, graphite, carbon nanotubes, carbon fibers, glass fibers, or the like. However, any known inorganic filler used for resin molding may be applied.

The plastic material may include, e.g., 5 wt % to 80 wt % of the filler, based on a total weight of the plastic material. When the filler content is less than 5 wt %, the plastic material may fail to satisfy a required predetermined strength, and the water-vapor permeability may not be sufficiently improved. When the filler content exceeds 80 wt %, moldability may decrease.

The plastic material may further include additives in addition to the base resin and the filler. In some embodiments, the additive may be or include, e.g., a catalyst, a plasticizer, a lubricant, a cross-linking agent, a desiccant, a release agent, or a flame retardant.

After the base resin and the filler are mixed and molded, the plastic material may be cross-linked by electron-beam irradiation or heat. The plastic material may be prepared by mixing the base resin, the filler, and a cross-linking agent. That is, the plastic material may be, e.g., cross-linked.

In some embodiments, after mixing a thermoplastic resin, e.g., a polypropylene (PP) resin, a polyethylene (PE) resin, or a polyacrylic acid (PAA) resin, with the filler and molding, the molded product may undergo a cross-linking treatment to exhibit thermosetting resin characteristics. The polyacrylic acid (PAA) resin, which may be a thermoplastic resin, may be, e.g., imidized into a polyimide (PI) resin, which is a thermosetting resin, through thermal cross-linking.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

To determine whether thermosetting-resin characteristics are satisfied, a compression test was performed using a thermomechanical analyzer (TMA). When a residual thickness after compression of a test piece is greater than or equal to 60% of the original thickness (that is, the thickness before the test), it may be determined that the thermosetting resin satisfies its characteristics.

Each compression test was performed using a test piece having a thickness of 100 μm under the conditions of a compressive load of 0.2 N, a measurement temperature of 300° C., and a heating rate of 10° C./min using the TMA to measure the residual thickness. The experimental data of Table 1 below was obtained under the conditions of a compressive load of 0.2 N, a measurement temperature of 300° C., and a heating rate of 10° C./min.

TABLE 1

| | Base resin | Cross-linking | Residual thickness [%] |
|---|---|---|---|
| Comparative | PE | — | 0 |
| Example 1 | | | |
| Comparative | PP | — | 0 |
| Example 2 | | | |
| Example 1 | PE | Electron-beam | 156 |
| Example 2 | PP | Electron-beam | 134 |

Referring to Table 1, Comparative Examples 1 and 2 show the residual thickness measured after the compression test of thermoplastic resins, polyethylene (PE) resin and polypropylene (PP) resin, that were not cross-linked. In contrast, Examples 1 and 2 show the residual thickness measured after the compression test of thermoplastic resins, polyethylene (PE) resin and polypropylene (PP) resin, that were cross-linked by electron beam irradiation.

As illustrated in Table 1, in Comparative Examples 1 and 2, where polyethylene (PE) resin and polypropylene (PP) resin, both thermoplastic resins, were not cross-linked, the resins melted at the melting point and no residual thickness remained.

In contrast, in Examples 1 and 2, where the thermoplastic polyethylene (PE) resin and polypropylene (PP) resin were cross-linked, it was confirmed that the cross-linking treatment increased resistance to compression, a characteristic of thermosetting resins, and improved durability at high temperatures, as evidenced by the resins not melting even at 300° C. and showing increased residual thickness after the compression test. Therefore, the plastic material may be cross-linked by electron-beam irradiation, heat, or a chemical cross-linking agent.

In some embodiments, in order to achieve weight reduction of the secondary battery, the plastic material may have a density less than or equal to 4.0 g/cm³. Additionally, in order to function as a case, the plastic material may have a tensile strength of greater than or equal to 50 MPa.

The plastic material may include, e.g., an inorganic filler having low hydrophilicity in order to improve moisture barrier performance. In some embodiments, the filler may include, e.g., glass fibers, carbon fibers, talc, calcium carbonate, or silica.

To evaluate the moisture barrier performance of the plastic material, a water-vapor transmission rate (WVTR) was measured. The WVTR was measured under conditions of 40° C., a relative humidity of 90%, and standard atmospheric pressure (1 atm). When the WVTR measured under those conditions is less than or equal to 15 g/(m²·day), moisture barrier performance is considered excellent. When the WVTR exceeds 15 g/(m²·day), moisture may penetrate the interior of the case or a solvent and an organic additive of the electrolyte may volatilize to the outside of the case. Moisture penetration into the interior of the case may cause the electrolyte to hydrolyze, thereby degrading battery performance. When the solvent and the organic additive of the electrolyte volatilize to the outside of the case, electrolyte composition and capacity inside the secondary battery may change, thereby degrading battery performance.

TABLE 2

| | | | | | Tensile | Residual |
|---|---|---|---|---|---|---|
| | Base resin | Filler | Density | WVTR | strength | thickness |
| | (composition) | (composition) | [g/cm³] | [g/m² · day] | [MPa] | [%] |
| Example 3 | PE | Glass fiber | 1.59 | 0.3 | 265 | 156 |
| | (60 wt %) | (40 wt %) | | | | |
| Example 4 | PE | Carbon fiber | 1.29 | 0.4 | 424 | 134 |
| | (60 wt %) | (40 wt %) | | | | |
| Example 5 | PE | Talc | 1.63 | 0.6 | 164 | 140 |
| | (60 wt %) | (40 wt %) | | | | |
| Example 6 | PE | Calcium | 1.64 | 0.6 | 203 | 143 |
| | (60 wt %) | carbonate | | | | |
| | | (40 wt %) | | | | |
| Example 7 | PE | Silica | 1.61 | 1.8 | 211 | 135 |
| | (60 wt %) | (40 wt %) | | | | |

Referring to Table 2, Examples 3 through 7 show experimental data for plastic materials prepared by changing the type of filler. In Examples 3 through 7, polyethylene (PE) was used as the base resin, and glass fibers, carbon fibers, talc, calcium carbonate, or silica was used as the filler. Each plastic material was formed by mixing 60 wt % of the base resin with 40 wt % of the filler, based on a total weight of the plastic material, and then cross-linking by electron-beam irradiation.

As indicated in Table 2, all of Examples 3 through 7 satisfied the density requirement of less than or equal to 4.0 g/cm³, the WVTR requirement of less than or equal to 15 g/(m²·day), the tensile-strength requirement of greater than or equal to 50 MPa, and the residual-thickness requirement of greater than or equal to 60%.

Therefore, the plastic material may include a filler including, e.g., glass fibers, carbon fibers, talc, calcium carbonate, or silica.

TABLE 3

| | | | | | Tensile | Residual |
|---|---|---|---|---|---|---|
| | Base resin | Filler | Density | WVTR | strength | thickness |
| | (composition) | (composition) | [g/cm³] | [g/(m² · day)] | [MPa] | [%] |
| Example 8 | PE | Glass fiber | 1.00 | 2.8 | 54 | 139 |
| | (95 wt %) | (5 wt %) | | | | |
| Example 9 | PE | Glass fiber | 1.09 | 1.7 | 89 | 144 |
| | (90 wt %) | (10 wt %) | | | | |
| Example 10 | PE | Glass fiber | 1.26 | 0.8 | 155 | 167 |
| | (80 wt %) | (20 wt %) | | | | |
| Example 11 | PE | Glass fiber | 1.93 | 0.2 | 389 | 150 |
| | (40 wt %) | (60 wt %) | | | | |
| Example 12 | PE | Glass fiber | 2.26 | 0.1 | 465 | 126 |
| | (20 wt %) | (80 wt %) | | | | |

Referring to Table 3, Examples 8 through 12 show experimental data for plastic materials prepared by changing the filler content. The filler content may be 5 wt % to 80 wt %, based on a total weight of the plastic material. When the filler content is less than 5 wt %, based on a total weight of the plastic material, the plastic material may fail to satisfy a predetermined strength, and the WVTR may not sufficiently improve. When the filler content exceeds 80 wt %, based on a total weight of the plastic material, moldability may decrease. Examples 8 to 12 were prepared by mixing polyethylene (PE) resin and glass fiber, molding them, and then subjecting them to electron beam cross-linking.

As shown in Table 3, each of Examples 8 through 12 satisfied the requirements of having a density of less than or equal to 4.0 g/cm³, a WVTR less than or equal to 15 g/(m²·day), a tensile strength of greater than or equal to 50 MPa, and a residual thickness of greater than or equal to 60%.

Therefore, the plastic material may include, e.g., 20 wt % to 95 wt % of the base resin and 5 wt % to 80 wt % of the filler, based on a total weight of the plastic material.

TABLE 4

| | | | | | Tensile | Residual |
|---|---|---|---|---|---|---|
| | Plastic material | | Density | WVTR | strength | thickness |
| | (composition) | Cross-linking | [g/cm³] | [g/m² · day] | [MPa] | [%] |
| Example 13 | PP + glass fiber | Electron-beam | 1.59 | 0.2 | 293 | 128 |
| | (60 wt % + 40 wt %) | | | | | |
| Example 14 | PP + glass fiber | Chemical | 1.59 | 0.5 | 305 | 137 |
| | (60 wt % + 40 wt %) | cross-linking | | | | |
| | | agent | | | | |
| Example 15 | PAA + glass fiber | Heat | 1.88 | 2.6 | 475 | 101 |
| | (60 wt % + 40 wt %) | | | | | |
| Example 16 | Epoxy + glass fiber | Chemical | 2.15 | 10.3 | 855 | 106 |
| | (60 wt % + 40 wt %) | cross-linking | | | | |
| | | agent | | | | |

Referring to Table 4, Examples 13 through 16 provide experimental data for plastic materials prepared using different cross-linking methods. Example 13 was obtained by mixing 60 wt % polypropylene PP resin with 40 wt % glass fiber, based on a total weight of the plastic material, molding the mixture, and then performing electron-beam irradiation. Example 14 was obtained by mixing polypropylene PP resin and glass fiber at a weight ratio of 60:40, adding a chemical cross-linking agent, and molding the mixture. Example 15 was obtained by mixing 60 wt % polyacrylic acid PAA resin with 40 wt % glass fiber, based on a total weight of the plastic material, molding the mixture, and then performing heat cross-linking. Example 16 was obtained by mixing epoxy resin and glass fiber at a weight ratio of 60:40, adding a chemical cross-linking agent, and molding the mixture.

As illustrated in Table 4, all of Examples 13 through 16 satisfy the requirements of having a density less than or equal to 4.0 g/cm³, a WVTR less than or equal to 15 g/(m²·day), a tensile strength of greater than or equal to 50 MPa, and a residual thickness of greater than or equal to 60%.

Accordingly, the plastic material may be cross-linked by, e.g., electron-beam irradiation, heat cross-linking, or chemical-agent cross-linking.

In some embodiments, the plastic material may have a thickness within a range of 100 μm to 300 μm, inclusive. When the thickness of the plastic material is less than 100 μm, mechanical strength may decrease, and when the thickness exceeds 300 μm, an overall size of the secondary battery may increase, making it difficult to achieve weight reduction.

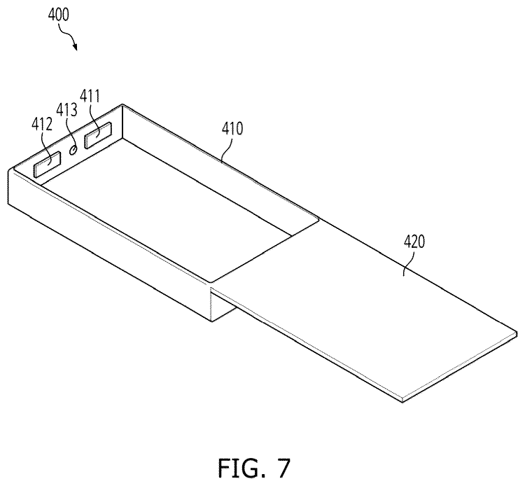

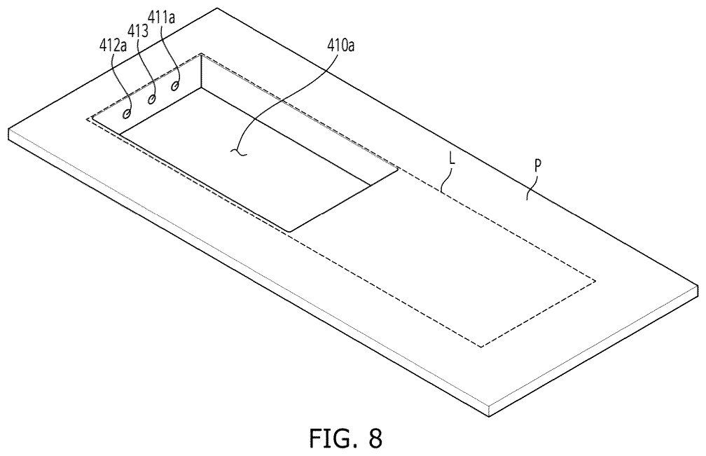

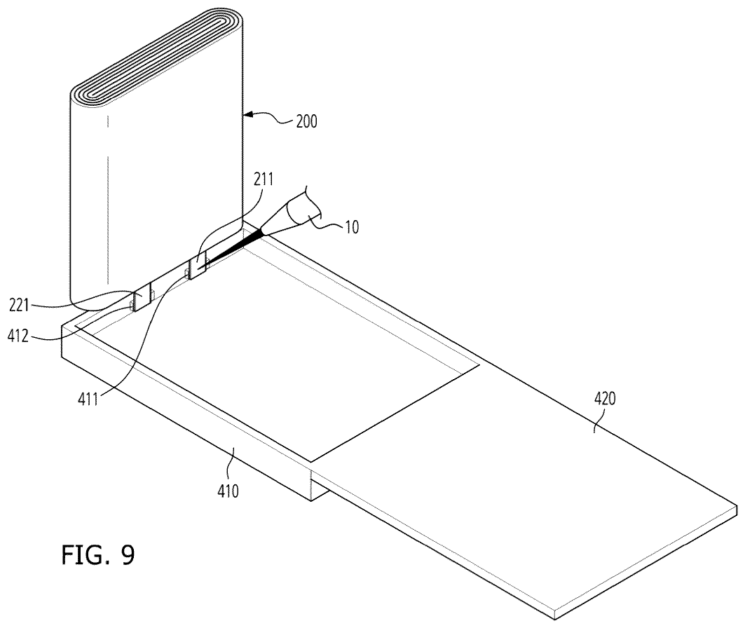

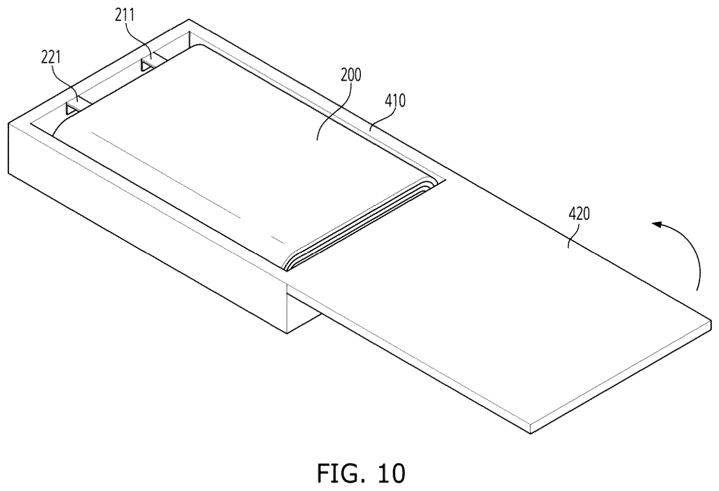

FIG. 7 is a perspective view illustrating an example of a case of a secondary battery according to other embodiments of the present disclosure; FIG. 8 is a perspective view illustrating a state of manufacturing a case of a secondary battery according to other embodiments of the present disclosure; FIG. 9 is a perspective view illustrating an example in which electrodes of an electrode assembly are electrically connected to electrode terminals of a case body in a secondary battery according to other embodiments of the present disclosure; and FIG. 10 is a perspective view illustrating an example in which, after the electrode assembly is accommodated in the case body of a secondary battery according to other embodiments of the present disclosure, a case cover is coupled to the case body.

Referring to FIGS. 7 through 10, in other embodiments, the secondary battery may have a case 400 whose shape differs from that of the case 300 described with reference to FIG. 4.

In some embodiments, the case 400 may include, e.g., a case body 410 that accommodates the electrode assembly 200 and a case cover 420 that extends from one end of the case body 410 and, after the electrode assembly 200 is accommodated in the case body 410, is bent and coupled to an open side of the case body 410; thus, the case body 410 and the case cover 420 may be integrally formed. For example, the case body 410 and the case cover 420 may be a single continuous component.

Referring to FIG. 8, the case may be formed to include, e.g., a receiving recess 410a, which may receive the electrode assembly, in a plastic material P by, e.g., injection molding, compression molding, vacuum molding, or deep drawing, and then cutting the plastic material P along a cutting line L.

A first coupling hole 411a, a second coupling hole 412a, and an electrolyte inlet 413 may be, e.g., formed on one side surface where the receiving recess 410a is formed. The first coupling hole 411a, the second coupling hole 412a, and the electrolyte inlet 413 may be formed by drilling after the receiving recess 410a is formed in the plastic material P, or may be formed simultaneously with the receiving recess 410a during injection-molding.

A first electrode terminal 411 and a second electrode terminal 412 may be coupled to the first coupling hole 411a and the second coupling hole 412a, respectively. The first electrode terminal 411 and the second electrode terminal 412 may be insert-molded in a mold, and resin may be injected into the mold to integrally form the case body 410 together with the first electrode terminal 411 and the second electrode terminal 412.

Referring to FIG. 9, after the first electrode terminal 411 and the second electrode terminal 412 are coupled to the case body 410, a first lead tab 211 of the electrode assembly 200 may be coupled to the first electrode terminal 411, and a second lead tab 221 of the electrode assembly 200 may be coupled to the second electrode terminal 412, thereby being electrically connected. In some embodiments, the first lead tab 211 and the second lead tab 221 may be laser-welded to the first electrode terminal 411 and the second electrode terminal 412, respectively, by a laser device 10.

Referring to FIG. 10, after the first lead tab 211 and the second lead tab 221 may be coupled to the first electrode terminal 411 and the second electrode terminal 412, respectively, the first lead tab 211 and the second lead tab 221 may be bent, and the electrode assembly 200 may be accommodated in the case body 410. Then, a case cover 420 may be connected to one end of the case body 410, and the portion where the case body 410 and the case cover 420 may be connected may be bent to dispose the case cover 420 on the open side of the case body 410, and the case cover 420 may be combined with the case body 410 to seal it. The case body 410 and the case cover 420 may be coupled by laser welding, thermal fusion, or the like.

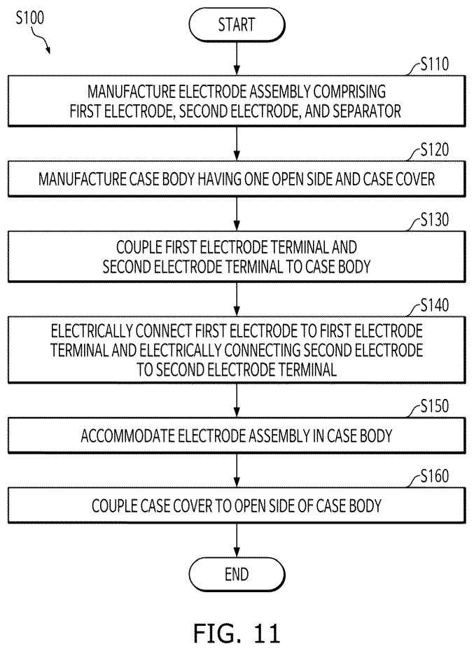

FIG. 11 is a flowchart illustrating an example of a method of manufacturing a secondary battery according to some embodiments of the present disclosure.

Referring to FIG. 11, a method S100 of manufacturing a secondary battery according to some embodiments of the present disclosure may include, e.g., manufacturing an electrode assembly including a first electrode, a second electrode, and a separator (S110); manufacturing a case body having one open side and a case cover (S120); coupling a first electrode terminal and a second electrode terminal to the case body (S130); electrically connecting the first electrode to the first electrode terminal and electrically connecting the second electrode to the second electrode terminal (S140); accommodating the electrode assembly in the case body (S150); and coupling the case cover to the open side of the case body (S160).

Step S110 may include, e.g., winding or stacking a stack of a first electrode, a separator, and a second electrode, each of which may be formed as a thin plate or film.

Step S120 may include, e.g., manufacturing the case body and the case cover from a plastic material including a base resin and a filler.

The case body and the case cover may be manufactured from the plastic material including the base resin and the filler by, e.g., injection molding, compression molding, vacuum molding, extrusion molding, or deep drawing.

In some embodiments, the base resin may include a thermosetting resin including, e.g., an epoxy resin, an amino resin, a phenolic resin, a polyester resin, a polyurethane resin, a melamine resin, or a polyimide PI resin. The base resin may include at least one thermoplastic resin including, e.g., a polypropylene PP resin, a polyethylene PE resin, or a polyacrylic acid PAA resin.

The filler may include an inorganic filler including, e.g., a carbonate filler, a sulfate filler, a metal-oxide filler, a composite-oxide filler, a metal-hydroxide filler, a metal-nitride filler, or a carbon-based filler.

In some embodiments, the inorganic filler may include, e.g., calcium carbonate, barium sulfate, talc, mica, potassium titanate, silica, natural minerals, titanium oxide, zinc oxide, alumina, boehmite, aluminum hydroxide, boron nitride, graphite, carbon nanotubes, carbon fibers, glass fibers, calcium carbonate, or the like. However, any known inorganic filler used for resin molding may be applied.

The plastic material may include, e.g., 5 wt % to 80 wt % of the filler, based on a total weight of the plastic material. When the filler content is less than 5 wt %, based on a total weight of the plastic material, the plastic material may fail to satisfy a predetermined strength (e.g., the plastic material may not have the required strength), and a water-vapor permeability may not be sufficiently improved. When the filler content exceeds 80 wt %, based on a total weight of the plastic material, moldability may decrease.

The plastic material may further include additives in addition to the base resin and the filler. In some embodiments, the additive may be or include, e.g., a catalyst, a plasticizer, a lubricant, a cross-linking agent, a desiccant, a release agent, or a flame retardant.

After the base resin and the filler are mixed and molded, the plastic material may be cross-linked by electron-beam irradiation or heat. The plastic material may be prepared by mixing the base resin, the filler, and the cross-linking agent. That is, the plastic material may be cross-linked.

The plastic material may be prepared to satisfy predetermined thermosetting-resin characteristics. If the residual thickness of the plastic material under a compressive load of 0.2N, at a measurement temperature of 300° C. to 400° C., and at a heating rate of 10° C./min measured by a thermomechanical analyzer is at least 60% of the original thickness, it may be determined that it satisfies thermosetting-resin characteristics.

In some embodiments, in order to achieve weight reduction of the secondary battery, the plastic material may be formed to satisfy a density less than or equal to 4.0 g/cm³. The plastic material may be formed to satisfy a tensile strength of greater than or equal to 50 MPa so as to function as a case.

To evaluate moisture-barrier performance of the plastic material, a water-vapor transmission rate may be measured under conditions of 40° C., a relative humidity of 90%, and standard atmospheric pressure 1 atm. When the water-vapor transmission rate measured under the conditions is less than or equal to 15 g/(m²·day), moisture-barrier performance may be considered excellent. When the water-vapor transmission rate exceeds 15 g/(m²·day), moisture may penetrate an interior of the case, or a solvent and an organic additive of the electrolyte may volatilize to an exterior of the case.

Therefore, the plastic material may be prepared to simultaneously satisfy a density less than or equal to 4.0 g/cm³, a water-vapor transmission rate less than or equal to 15 g/(m²·day), a tensile strength of greater than or equal to 50 MPa, and a residual thickness of greater than or equal to 60%.

In some embodiments, the plastic material may have a thickness within a range of 100 μm to 300 μm, inclusive. When the thickness of the plastic material is less than 100 μm, mechanical strength may decrease. When the thickness exceeds 300 μm, overall size of the secondary battery may increase, and achieving weight reduction may be difficult.

Step S130 may include, e.g., coupling the first electrode terminal and the second electrode terminal to first and second coupling holes formed in the case body, respectively. The first electrode terminal and the second electrode terminal may be insert-molded in a mold, and resin may be injected into the mold to integrally form the case body together with the first electrode terminal and the second electrode terminal.

In step S140, after the first electrode terminal and the second electrode terminal may be coupled to the case body, the first lead tab of the electrode assembly may be coupled to the first electrode terminal, and the second lead tab of the electrode assembly may be coupled to the second electrode terminal, thereby being electrically connected. In some embodiments, the first lead tab and the second lead tab may be laser-welded to the first electrode terminal and the second electrode terminal, respectively, by the laser device.

Step S150 may include, e.g., after the first lead tab and the second lead tab are coupled to the first electrode terminal and the second electrode terminal, respectively, bending the first lead tab and the second lead tab and accommodating the electrode assembly in the case body.

Step S160 may include, e.g., disposing the case cover on the open side of the case body, and then coupling the case cover to the case body to seal it. In some embodiments, step S160 may include, e.g., methods such as laser welding or thermal fusion to couple the case body and the case cover.

By way of summation and review, a case of the secondary battery may be manufactured from a metal material, e.g., aluminum or stainless steel (SUS), or may be manufactured in a pouch form from an insulating material. However, when the case of the secondary battery is manufactured from the metal material, the case may have high strength but may also be heavy, and when the case is manufactured in the pouch form from the insulating material, the case may be light but may also have low strength.

Embodiments provide secondary batteries and methods for manufacturing the secondary batteries that resolve the above-described problems.

Aspects and features of the present disclosure are described in, or are apparent from, the above description of embodiments of the present disclosure.

According to some embodiments of the present disclosure, the case of the secondary battery may be formed of a plastic material, thereby reducing the weight and ensuring a certain level of strength.

However, aspects and features of the present disclosure are not limited to those described above, and other aspects and features that are not expressly described will be clearly understood by a person having ordinary skill in the art from the following detailed description.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
an electrode assembly including a first electrode, a second electrode, and a separator; and
a case accommodating the electrode assembly and an electrolyte, the case including a plastic material including a base resin and a filler.

2. The secondary battery as claimed in claim 1, wherein the plastic material has a residual thickness of greater than or equal to 60% of an original thickness as measured by a thermomechanical analyzer under a compressive load of 0.2 N, at a measurement temperature of 300° C. to 400° C., and at a heating rate of 10° C./min.

3. The secondary battery as claimed in claim 1, wherein the plastic material has a density of less than or equal to 4.0 g/cm³.

4. The secondary battery as claimed in claim 1, wherein the plastic material has a water-vapor transmission rate of less than or equal to 15 g/(m²·day) under conditions of 40° C., a relative humidity of 90%, and standard atmospheric pressure.

5. The secondary battery as claimed in claim 1, wherein the plastic material has a tensile strength of greater than or equal to 50 MPa.

6. The secondary battery as claimed in claim 1, wherein the plastic material has a thickness of 100 μm to 300 μm.

7. The secondary battery as claimed in claim 1, wherein the base resin includes a thermosetting resin including an epoxy resin, an amino resin, a phenolic resin, a polyester resin, a polyurethane resin, a melamine resin, or a polyimide resin.

8. The secondary battery as claimed in claim 1, wherein the base resin includes a thermoplastic resin including a polypropylene resin, a polyethylene resin, or a polyacrylic acid resin.

9. The secondary battery as claimed in claim 1, wherein the plastic material includes 5 wt % to 80 wt % of the filler, based on a total weight of the plastic material.

10. The secondary battery as claimed in claim 1, wherein the filler includes an inorganic filler including a carbonate filler, a sulfate filler, a metal-oxide filler, a composite-oxide filler, a metal-hydroxide filler, a metal-nitride filler, or a carbon-based filler.

11. The secondary battery as claimed in claim 1, wherein the plastic material includes an additive including a catalyst, a plasticizer, a lubricant, a cross-linking agent, a desiccant, a release agent, or a flame retardant.

12. The secondary battery as claimed in claim 1, wherein the plastic material is cross-linked by electron-beam irradiation, heat, or a chemical cross-linking agent.

13. The secondary battery as claimed in claim 1, wherein the case includes:
a case body having an open side and including a first electrode terminal electrically connected to the first electrode and a second electrode terminal electrically connected to the second electrode, and
a case cover coupled to the open side of the case body.

14. The secondary battery as claimed in claim 13, wherein the case body and the case cover are a single continuous component and the case cover extends from one end of the case body and is bent and coupled to the open side of the case body.

15. A method of manufacturing a secondary battery, the method comprising:
manufacturing an electrode assembly including a first electrode, a second electrode, and a separator;
manufacturing a case body having an open side and a case cover;
coupling a first electrode terminal and a second electrode terminal to the case body;
electrically connecting the first electrode to the first electrode terminal and electrically connecting the second electrode to the second electrode terminal;
accommodating the electrode assembly in the case body; and
coupling the case cover to the open side of the case body,
wherein the case body and the case cover are formed of a plastic material including a base resin and a filler.

16. The method as claimed in claim 15, wherein the plastic material has a residual thickness of greater than or equal to 60% of an original thickness as measured by a thermomechanical analyzer under a compressive load of 0.2 N, at a measurement temperature of 300° C. to 400° C., and at a heating rate of 10° C./min.

17. The method as claimed in claim 15, wherein the plastic material has a density less of than or equal to 4.0 g/cm³.

18. The method as claimed in claim 15, wherein the plastic material has a water-vapor transmission rate of less than or equal to 15 g/(m²·day) under conditions of 40° C., a relative humidity of 90%, and standard atmospheric pressure.

19. The method as claimed in claim 15, wherein the plastic material has a tensile strength of greater than or equal to 50 MPa.

20. The method as claimed in claim 15, wherein the plastic material includes 5 wt % to 80 wt % of the filler, based on a total weight of the plastic material.
